(19) United States
(12) Patent Application Publication
(10) Pub. No.: US 2025/0105639 A1
(43) Pub. Date: Mar. 27, 2025

(54) SMART CHARGING ALLOCATION BOX

(71) Applicant: Yueqing Shenchuang Electric Technology Co., Ltd., Yueqing (CN)

(72) Inventor: Guangqiang WANG, Yueqing (CN)

(73) Assignee: Yueqing Shenchuang Electric Technology Co., Ltd., Yueqing (CN)

(21) Appl. No.: 18/474,902

(22) Filed: Sep. 26, 2023

(51) Int. Cl. H02J 7/00; H01R 13/703; H01R 13/717

(52) U.S. Cl. CPC H02J 7/0042; H01R 13/7031; H01R 13/717

(57) ABSTRACT

A smart charging allocation box includes a housing, a first socket, a second socket provided on the housing, and an microcontroller unit chip. A switch is provided between the first socket and the second socket, and the first socket and the second socket are connected in parallel to the main power line. The first socket has higher priority. When the first socket is working, the second socket is disconnected. When the first socket is off or below standby power, the second socket is available. The charging allocation box of the application can reasonably allocate the power demand of household appliances, effectively preventing the occurrence of hazards such as fires caused by a large workload due to multiple devices working simultaneously. It provides a reasonable allocation of power devices, ensuring safety and reliability.

### TECHNICAL FIELD

The present application relates to the field of power allocation boxes and particularly relates to a smart charging allocation box.

### BACKGROUND

During household electricity usage, it is often necessary to simultaneously use multiple high-power devices. However, when there are limited sockets available, it is common to connect multiple extension cords or power strips to a single socket, which can lead to excessive load on the circuit, resulting in blown fuses or power outages, causing inconvenience.

### SUMMARY

To address the above issues, the present application proposes a smart charging allocation box with a simple structure that can allocate power reasonably.

The present application provides a smart charging allocation box comprising a housing, a first socket, a second socket, and a microcontroller unit (MCU) chip mounted on the housing. A switch is provided between the first socket and the second socket. The first socket and the second socket are connected in parallel to the main power line. The priority of the first socket is higher than that of the second socket. When the first socket is working, the second socket is in the disconnected state. When the first socket is in the disconnected state or below standby power, the second socket is in the available state.

In the present application, a display screen is also provided on the housing. Additionally, a metering module is installed inside the housing to collect and process data, which can be displayed on the display screen.

In the present application, protectors are installed on both the first socket and the second socket.

In the present application, both the first socket and the second socket are equipped with a marquee light to display the working status of the sockets.

### BRIEF DESCRIPTION OF THE DRAWINGS

To further illustrate the technical solutions of the embodiments or the prior art more clearly, a brief introduction to the drawings required in the description of the embodiments or the prior art will be provided below. It is apparent that the drawings described below are merely some embodiments of the present application, and those skilled in the art can obtain other drawings based on these drawings without exercising inventive labor.

FIG. 1 is a schematic diagram of the circuit connection structure of the charging box according to this application.

### DETAILED DESCRIPTION OF THE EMBODIMENTS

Compared to the embodiments shown in the drawings, the feasible implementations within the scope of the present disclosure may have fewer components, additional components not shown in the drawings, different components, components arranged differently, or components connected differently. Additionally, two or more components shown in the drawings can be implemented in a single component, or a single component shown in the drawings can be implemented as multiple separate components.

Unless otherwise defined, the technical terms or scientific terms used herein should be understood in their ordinary meaning by those skilled in the art to which the present application belongs. The use of words such as “first,” “second,” or similar terms in the present application patent application and claims does not imply any order, quantity, or importance, but is merely used to distinguish different components. Similarly, words such as “one” or “a” do not necessarily indicate a numerical limitation. Words such as “including,” “comprising,” or “having” are intended to indicate that the elements or objects listed after the word are included, but do not exclude other elements or objects. Words such as “connected” or “communicatively coupled” are not limited to physical or mechanical connections or couplings shown in the drawings, but can include equivalent connections or couplings, whether direct or indirect. Words such as “up,” “down,” “left,” “right,” “horizontal,” or “vertical” are used to indicate relative positional relationships, which may change accordingly when the absolute position of the described object changes.

The technical solutions of the present application will be described clearly and comprehensively in conjunction with embodiments. It is apparent that the described embodiments are only part of the embodiments of the present application, and not all embodiments. Based on the embodiments disclosed in the present application, all other embodiments that can be obtained by those skilled in the art without inventive labor are within the scope of protection of the present application.

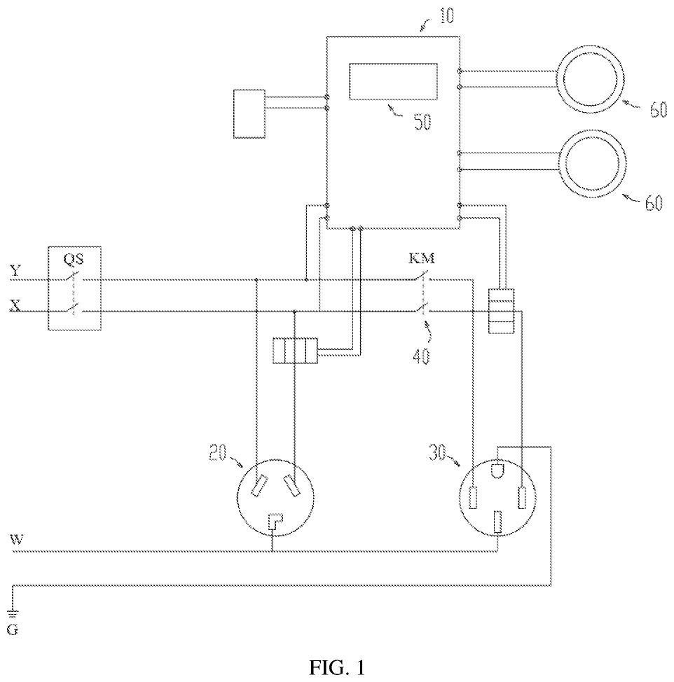

As shown in FIG. 1, the smart charging allocation box mainly includes a housing 10, a first socket 20, a second socket 30, a control module, a metering module, and a main circuit board located inside the housing 10. Furthermore, there is a main line on the housing 10 for connecting to the main power supply. When the main line is connected to the main circuit of the household power supply or the circuit to be divided, the smart charging allocation box can be used. The housing 10 also has a main display screen 50 for displaying desired parameters or socket operating status, output power, voltage, etc.

Specifically, different types of sockets can be used for the assembly of the first socket 20 and the second socket 30. The first socket 20 and the second socket 30 are connected in parallel on the main line, meaning that both sockets are on the same neutral line and live wire.

During use, the first socket 20 is in the first priority state, and the second socket 30 is in the second priority state. That is, when both the first socket 20 and the second socket 30 are plugged with electrical devices, both devices are turned on. At this time, the smart charging allocation box prioritizes supplying power to the electrical device on the first socket 20, while the second socket 30 remains disconnected.

Specifically, to achieve this action, there is a switch 40 between the first socket 20 and the second socket 30. When the electrical device on the first socket 20 is disconnected or in standby power mode, the switch 40 conducts, and the second socket 30 starts to supply power.

It should be noted that there are wires on both the first socket 20 and the second socket 30 for data collection. These wires are connected to the microcontroller unit chip on the main circuit board, which processes and analyzes the predetermined data through the MCU chip and the metering module to determine the status of the first socket 20 and the second socket 30. The predetermined data is then displayed on the display screen 50.

If the electrical device on the second socket 30 is operating, and the electrical device on the first socket 20 starts to operate or has a power greater than the preset standby power, the switch 40 disconnects, and the power supply to the second socket 30 is stopped. Priority is given to supplying power to the electrical device on the first socket 20.

Specifically, there is also a marquee light 60 on both the first socket 20 and the second socket 30. The marquee light 60 can indicate the working status or faults of the sockets through different colors.

In particular, when the socket is in standby mode, the marquee light 60 is blue. When the socket is in working mode, the marquee light 60 is green. And when the socket has a fault, the marquee light 60 is red.

Both the first socket 20 and the second socket 30 are equipped with protectors on the neutral wire, effectively protecting the circuits of the housing 10.

The charging allocation box described in this application can reasonably allocate the power demand of household appliances, effectively preventing the occurrence of dangers such as fires caused by multiple electrical devices operating simultaneously and causing a heavy workload. It ensures the rational allocation of electrical devices and is safe and reliable.

The above-described embodiments are merely descriptions of preferred embodiments of the present application and do not limit the conception and scope of the application. Various modifications and improvements made by those skilled in the art within the scope of the technical solution of the present application, without departing from the design concept of the present application, should fall within the protection scope of the present application. The technical content to be protected by the present application is fully described in the claims.

What is claimed is:

1. A smart charging allocation box, comprising a housing, a first socket, a second socket provided on the housing, and a microcontroller unit chip; wherein
a switch is provided between the first socket and the second socket; the first socket and the second socket are connected in parallel on a main line, with the first socket having a higher priority than the second socket; when the first socket is working, the second socket is in a disconnected state, and when the first socket is in a disconnected state or below a standby power, the second socket is in an available state.

2. The smart charging allocation box according to claim 1, wherein a display screen is provided on the housing, and a metering module is provided inside the housing, which displays collected and processed data on the display screen.

3. The smart charging allocation box according to claim 2, wherein both the first socket and the second socket are equipped with protectors.

4. The smart charging allocation box according to claim 3, wherein both the first socket and the second socket are equipped with marquee lights for displaying a working status of the sockets.
